(19) United States
(12) Patent Application Publication
(10) Pub. No.: US 2011/0094830 A1
(43) Pub. Date: Apr. 28, 2011

(54) Vehicle and object portable lift

(76) Inventor: Kurt O'Ferrall Lund, Del Mar, CA (US)

(21) Appl. No.: 12/589,563

(22) Filed: Oct. 26, 2009

(51) Int. Cl. B66F 7/00

(52) U.S. Cl. 187/203

(57) ABSTRACT

A machine for lifting and/or rotating a vehicle or other object, comprising two or more column assemblies generally located on opposite sides of the vehicle or other object. Each assembly comprises a base, a support column, a lifting mechanism, optionally a cross beam connected to the lifting mechanism, and one or more transfer beams that transfer vehicle or object loads to the column assemblies directly or via the cross beams. All loads are transferred substantially in the planes of the lifting mechanisms. the lift may be mounted on rollers and casters and, thus, movable; fastening of the lift to a floor is not required.

### BACKGROUND OF THE INVENTION

Almost everyone is familiar with the vehicle lift in use at the local garage or car repair shop. Traditionally, these lifts have relied on a massive hydraulic column or cylinder for the lifting function, where the column and actuator cylinder are buried deep under the floor, in this case the car is located centrally to the column and transmits loads to the column through here-called “spreader-beams”. More recently, these lifts employ smaller hydraulic- or screw-actuated columns above the floor, at sides next to the car, but are still fabricated from massive steel sections that are securely fastened to the floor, this fastening of massive steel is necessary to accommodate bending moments induced by the spreader-beams that extend from the lift-columns to the car wheels or undercarriage.

By contrast, the present invention transmits the loads from the vehicle, or other heavy object, to the lifting columns such that the loads are coplanar with the columns, thus avoiding bending moments; in this way, much smaller and economical steel sections may be employed. Because of the coplanar, balanced loads and these smaller, lighter sections, the columns of the present invention need not be fastened to the floor, but can be mounted on a movable base with wheels and, hence, be fully portable.

There is another type of lifting device that is used in home garages for storing one vehicle over the top of another, typically, these have four columns with a cable system for lifting the car. Although this arrangement has been employed for limited undercarriage access, such as muffler replacements, it is not favored for general automobile repair; nor are these types easily portable. Other lifts employ ramps or bumper-type lift-columns.

The present invention, primarily employing two columns, provides for open, convenient access to most of the undercarriage. The system is fully portable so that it can be placed aside when not in use, a feature that is important for home- and small-garages.

Additionally, the present system can act as a hoist or gantry crane to, for example, hoist an engine out of a car, or lift a heavy object onto a truck.

### SUMMARY OF THE INVENTION

Lifting devices for vehicles are conventionally made of heavy steel sections that are immovable and secured to the floor. The present invention seeks to eliminate these disadvantages: Thus, transverse beams under the car prevent bending moments on the lift columns and transmit loads to cross-beams in the plane of the columns; leveled cross-beams further prevent bending moments to the lifting power-screw which, therefore, can have tension loads, only; these inventions greatly lower the mass of structural steel. Furthermore, the much-lightened lift-columns can be supported by a stable platform, on wheels, which renders the whole lifting machine movable and portable when not in use. In summary, the invention is stated as follows:

A Machine for Lifting a Vehicle or other Objects, comprising:
several stabilized columns with screws, nuts, and power units to effect lifting;
statically stable base units with roller supports that accept column loads;
leveled, roller- or cable-guided cross-beams containing the nuts and screws;
under-object transverse beams that eliminate moments to cross beams;
a user actuated controller that controls power to individual power units.

### BRIEF DESCRIPTION OF THE DRAWINGS

FIG. 1 is a perspective view of the present invention, and of a vehicle on the lift.

FIG. 2 is a cross section view of the lifting-column assembly.

FIG. 3 is an end view of the lifting columns with a vehicle.

### DETAILED DESCRIPTION OF THE PREFERRED EMBODIMENTS

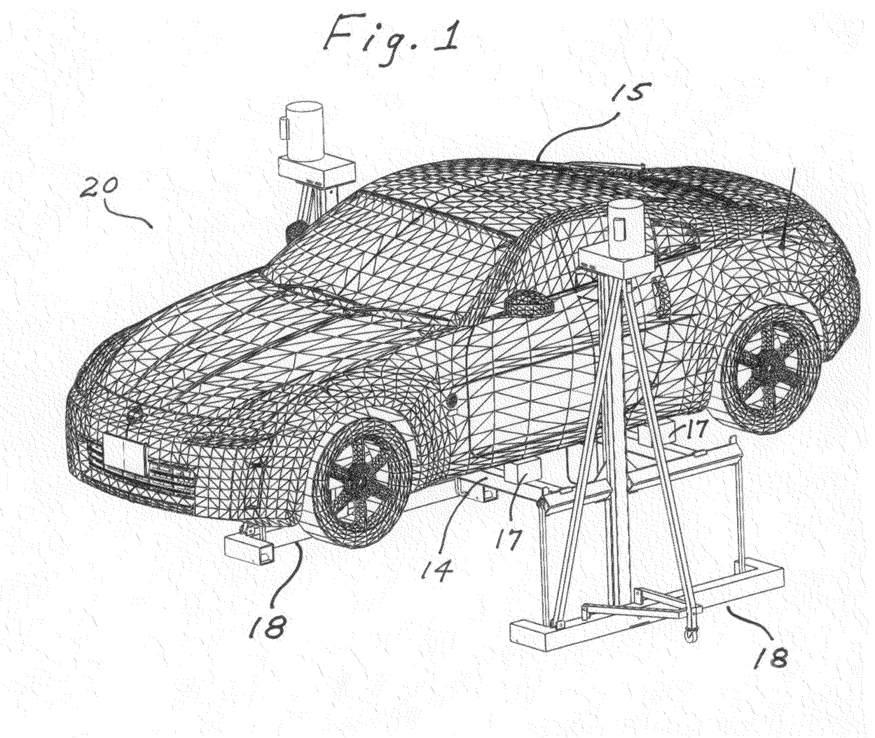

The device of the present invention is used for lifting a vehicle or other heavy object. FIG. 1 is a perspective view of a preferred embodiment 20 of the invention; the particular embodiment shown comprises two lifting column assemblies 18; it furthermore shows a vehicle 15 resting on support blocks 17, which rest on transfer beams 14, and which further rest on lifting column assemblies 18.

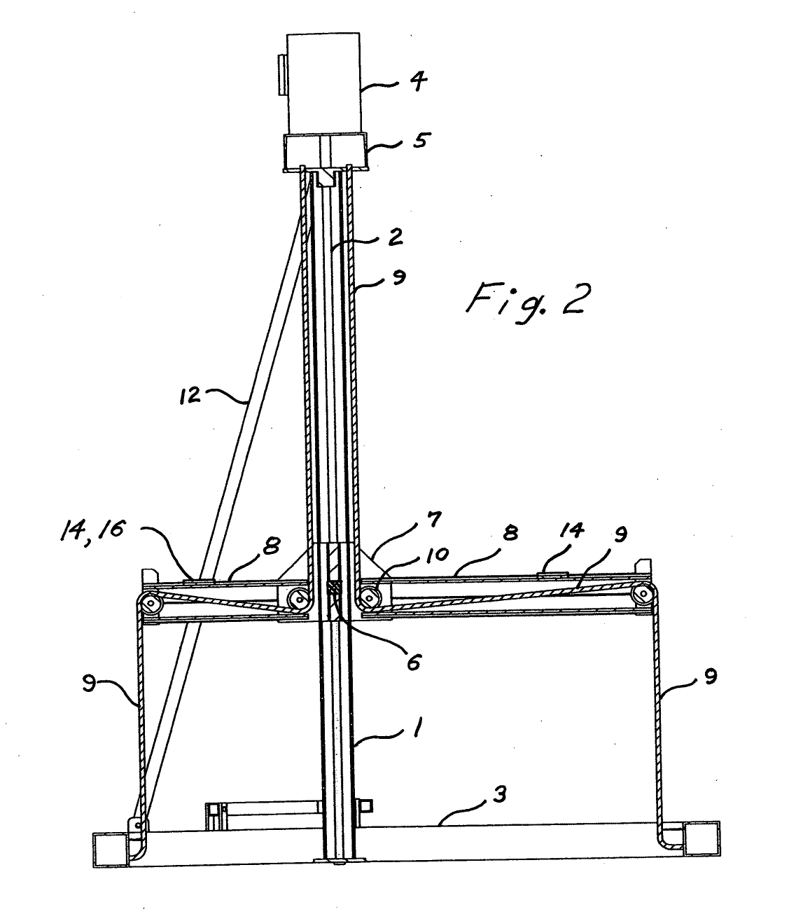

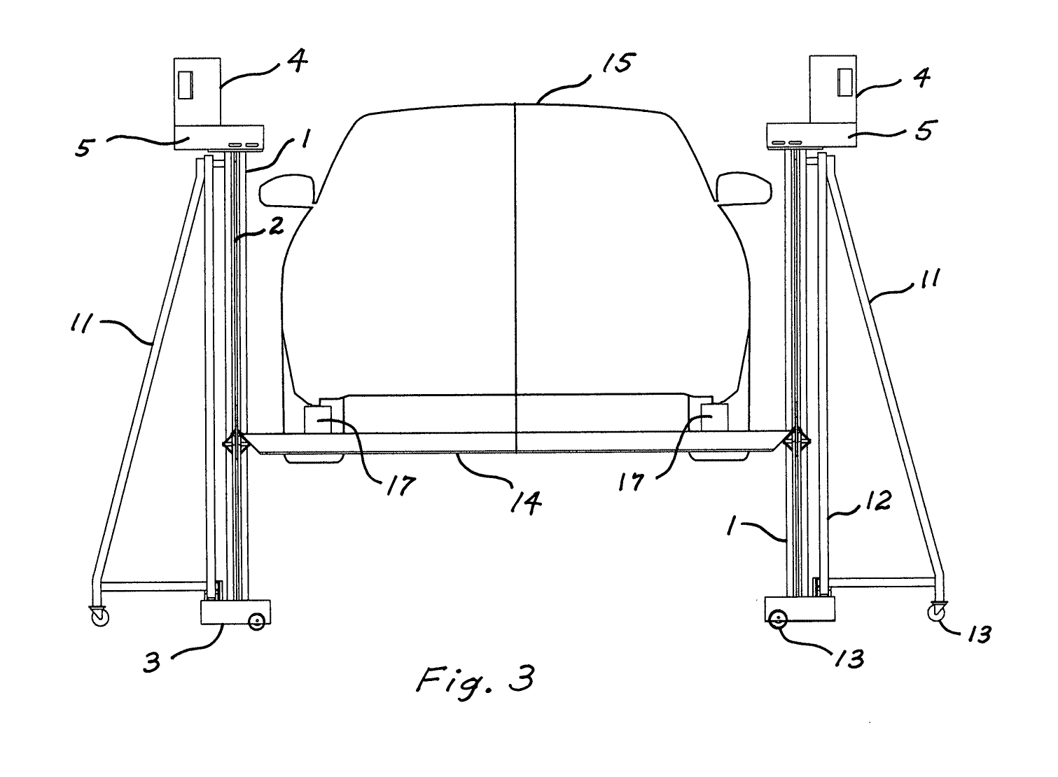

The lifting device is based on a power screw 2 suspended from a column 1, said column being attached to base 3, as shown in FIGS. 2 and 3. The power screw is driven by a motor 4 through a gear or pulley speed-reduction stage 5. The power screw 2 is threaded through a nut 6 that is affixed to gusset plate 7. Cross beams 8 are rigidly fixed to the gusset plate. The gusset-plate, nut, cross-beam assembly can move vertically along the column and is stabilized laterally by cables 9; the cables 9 pass over pulleys 10 such that the said assembly can freely move up and down but is prevented from lateral rotation. In another embodiment, lateral rotation may be prevented by rollers that roll on the column surfaces. The column is prevented from rotating transversely by stiffening member 11 and laterally by stiffening member 12. The base may be supported by rollers and casters 13. This description comprises one of two columns with power screw assemblies. Between the two columns are two transfer beams 14 which support the vehicle or lifted object 15. The transfer beams 14 rest upon the cross-beams 8 in such a way that vertical loads are transferred without inducing turning moments or torques on the cross-beams and column assemblies. This may be achieved by a saddle 16, welded onto transfer beam 14, and resting upon the cross-beams 8 in the center-planes of the columns 1. Cross-beams 8 may be generally diamond shaped or square in elevation view, or round.

In operation, the vehicle or object is placed between two columns. The transfer beams are placed under the vehicle, or under or over the object; in operation with the transfer beams over the object, various cables, chains, or slings are used to fasten the object to the beams. The columns 1 are moved on rollers 13 and the transfer beams 14 engaged to the cross-beams 8, and support blocks 17 are placed at strategic locations under the vehicle. Each of the motors 4 is controlled independently by a handheld switch box. The cross-beam assemblies are then elevated, more or less simultaneously, thus lifting the vehicle or object. The lateral placements of the vehicle or object and the transfer beams are such as to more or less balance the vehicle or object, causing the load to be taken up predominantly by the two power screws, and only a lesser load on the stabilizing cables.

What is claimed is:

1. A machine for lifting and/or rotating a vehicle or other object comprising:
two or more column assemblies, generally located on opposite sides of the vehicle or other object, wherein each assembly comprises a base, a support column, a lifting mechanism, and optionally a cross beam connected to said lifting mechanism; and one or more transfer beams that transfer vehicle or object loads to said column assemblies directly or via the cross beams, wherein the said loads are transferred substantially in the planes of said lifting mechanisms.

2. The vehicle lift of claim 1 wherein each said transfer beam transmits said vehicle or object loads to said cross beams substantially as point-loads or line-loads.

3. The vehicle lift of claim 1 with an anti-rotation mechanism that substantially prevents rotation of each said cross beam in its said plane; wherein the mechanism may be either a cable and pulley system or a roller system.

4. The vehicle lift of claim 1 wherein the base of each column assembly is provided with the means for attaching said columns to the floor.

5. The vehicle lift of claim 1 wherein each column assembly is provided with a statically stable base that safely accepts loads from said columns, with said columns not being attached to the floor.

6. The vehicle lift of claim 1 wherein each column assembly is provided with a statically stable base that safely accepts loads from said columns, with said base not being attached to the floor and provided with rollers or wheels.

7. The vehicle lift of claim 1 wherein each column assembly is provided with a statically stable base that safely accepts loads from said columns, with said base not being attached to the floor and provided with rollers or wheels for relocation when not in operation, and with said base comprising an automatic anti-relocation device when in operation, wherein said anti-relocation device comprises a deformable portion of the base which elastically deforms under load to contact the floor.

8. The vehicle lift of claim 1 further comprising one or more user-actuated controllers, or switches, that control the power to each of the said lifting mechanisms.

9. The vehicle lift of claim 1 further comprising a central control unit which controls all the lifting mechanisms via one or more user actuated controllers.

10. The vehicle lift of claim 1 wherein said transfer beams are movable.

11. The vehicle lift of claim 1 wherein the vehicle or object load is transferred to said transfer beams via locatable contact pads.

12. The vehicle lift of claim 1 wherein the lifting mechanism is a power screw, or a hydraulic cylinder with lifting chains or cables.

13. The vehicle lift of claim 1 wherein the lifting mechanism is a power screw of an inherently safe design that will not allow rotation of the power screw except under powered conditions.

14. The vehicle lift of claim 1 with central or independent lifting control units wherein the units require a removable key or an actuation code to operate.

15. The vehicle lift of claim 1 where each lifting mechanism is driven by a standard electric motor via a V-belt or geared reducer.

16. The vehicle lift of claim 1 wherein some or all of the lifting mechanisms are supported from the top of the columns.

17. The vehicle lift of claim 1 wherein some or all of the lifting mechanisms are supported by an anti-friction, roller-type thrust bearing.

18. The vehicle lift of claim 1 wherein the lifting mechanism is a power screw, wherein said screw is loaded substantially in tension, only.

19. The vehicle lift of claim 1 wherein the transfer beam or beams is/are located under the vehicle or object.

20. The vehicle lift of claim 1 wherein the transfer beam or beams is/are located above the vehicle or object and attached to the said vehicle or object, such as an engine, via a tension device such as a cable, rope or chain.

21. The vehicle lift of claim 1 wherein each said transfer beam transmits said vehicle or object loads to said lifting mechanisms substantially as point-loads or line-loads.

22. The vehicle lift of claim 1 wherein each said vehicle or object loads are transmitted to said lifting mechanisms substantially as point-loads or line-loads.

23. The vehicle lift of claim 1 wherein said cross beams are of hollow, square cross sections, and wherein said transfer beams are provided with hanger shapes that substantially match to said square cross sections.

24. The vehicle lift of claim 1 wherein said cross beams are of hollow, circular cross sections, and wherein said transfer beams are provided with hanger shapes that substantially match to said circular cross sections.

25. The vehicle lift of claim 1 wherein said transfer beams are provided with hanger shapes that substantially transfer said loads as point-loads or line-loads, substantially in the plane of said lifting mechanisms.
